(19) United States
(12) Patent Application Publication
(10) Pub. No.: US 2017/0123464 A1
(43) Pub. Date: May 4, 2017

(54) ELECTRONIC DEVICE

(71) Applicant: Kabushiki Kaisha Toshiba, Tokyo (JP)

(72) Inventors: Yuichi HIRAI, Hamura Tokyo (JP); Shingo KOIDE, Tachikawa Tokyo (JP)

(21) Appl. No.: 15/058,069

(22) Filed: Mar. 1, 2016

Related U.S. Application Data
(60) Provisional application No. 62/247,386, filed on Oct. 28, 2015.

(51) Int. Cl. G06F 1/16

(52) U.S. Cl. CPC G06F 1/1686; G06F 1/169; G06F 1/1662; G06F 1/1696; G06F 1/1688

(57) ABSTRACT

According to an embodiment, an electronic device includes a housing, a first component, and a member. The first component is accommodated in the housing. The member to which the first component is attached is made of synthetic resin and is attached to the housing.

### CROSS-REFERENCE TO RELATED APPLICATIONS

This application is based upon and claims the benefit of priority from U.S. Provisional Application No. 62/247,386, filed on Oct. 28, 2015; the entire contents of which are incorporated herein by reference.

### FIELD

Embodiments to be described herein relate generally to an electronic device.

### BACKGROUND

Various types of components are accommodated in a housing of an electronic device. The components inside the electronic device are, for example, screwed to the housing.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating a portable computer according to an embodiment;

FIG. 2 is an exemplary perspective view illustrating a part of an exploded base portion according to the embodiment;

FIG. 3 is an exemplary cross-sectional view illustrating a part of the base portion according to the embodiment;

FIG. 4 is an exemplary perspective view illustrating a part of a top cover according to the embodiment;

FIG. 5 is an exemplary cross-sectional view illustrating a part of the base portion at a position different from that of FIG. 3 according to the embodiment;

FIG. 6 is an exemplary perspective view illustrating a fingerprint detection module, an attachment member, a plurality of first lenses, and a plurality of second lenses according to the embodiment;

FIG. 7 is an exemplary perspective view illustrating a part of the attachment member to which the fingerprint detection module and the plurality of first and second lenses are attached according to the embodiment;

FIG. 8 is an exemplary perspective view illustrating a part of the base portion according to the embodiment by removing a bottom cover;

FIG. 9 is an exemplary perspective view illustrating a top cover and the attachment member according to the embodiment; and

FIG. 10 is an exemplary perspective view illustrating a partially cut-out part of the base portion according to the embodiment.

### DETAILED DESCRIPTION

Generally, according to an embodiment, an electronic device includes a housing, a first component, and a member. The first component is accommodated in the housing. The member to which the first component is attached is made of synthetic resin, and is attached to the housing.

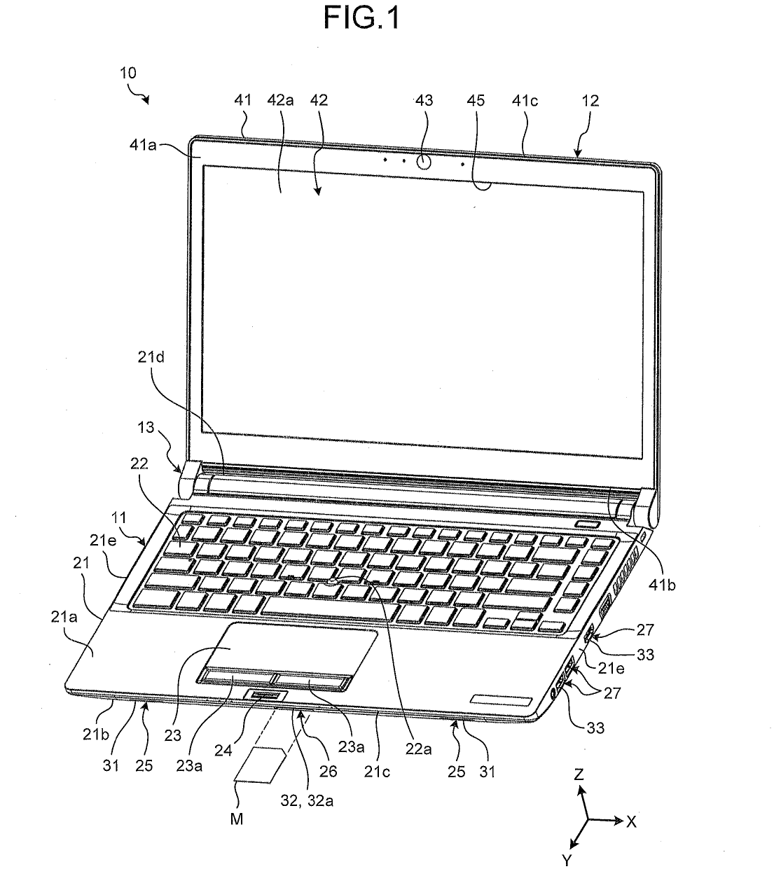

Hereinafter, an embodiment will be described with reference to FIGS. 1 to 10. Incidentally, the present specification basically defines a direction toward a user as a forward direction, a direction away from the user as a rearward direction, a left side seen from the user as a leftward direction, a right side seen from the user as a rightward direction, an upper side seen from the user as an upward direction, and a lower side seen from the user as a downward direction. Further, constituent elements or descriptions of the elements according to the embodiment will be sometimes described with a plurality of expressions. It is not hindered to use other expressions not described herein regarding the constituent element and the description thereof. In addition, it is not hindered to use other expressions regarding constituent elements and descriptions thereof which are not described with a plurality of expressions.

FIG. 1 is an exemplary perspective view illustrating a portable computer 10 according to the embodiment. The portable computer 10 is an example of the electronic device. The electronic device may be a tablet, a television receiving apparatus, a display, a smartphone, a mobile phone, consumer electronics or other electronic devices.

As illustrated in FIG. 1, the portable computer 10 includes a base portion 11, a display unit 12, and a hinge portion 13. Each of the base portion 11, the display unit 12, and the hinge portion 13 can be referred to also as a part.

As illustrated in the respective drawings, the present specification defines an X-axis, a Y-axis, and a Z-axis. The X-axis, the Y-axis, and the Z-axis are orthogonal to each other. The X-axis is defined along a width of the base portion 11. The Y-axis is defined along a depth of the base portion 11. The Z-axis is defined along a thickness of the base portion 11.

The base portion 11 includes a first housing 21, a keyboard 22, a touch pad 23, a fingerprint detection module 24, two speakers 25, a card reading device 26, and a plurality of connectors 27. The first housing 21 is an example of the housing. The fingerprint detection module 24 is an example of the first component. The speaker 25 is an example of a second component. Each of the keyboard 22, the touch pad 23, the fingerprint detection module 24, the speaker 25, the card reading device 26, and the connector 27 can be referred to also as, for example, a module, a unit, a component, or a part.

The first housing 21 accommodates the fingerprint detection module 24, the speakers 25, the card reading device 26, and the connectors 27. The first housing 21 further accommodates, for example, a motherboard, to which a CPU and a memory are mounted, a storage such as a solid state drive (SSD), and a battery.

The first housing 21 is formed substantially in a rectangular box shape. The first housing 21 maybe formed in another shape. The first housing 21 includes an upper face 21a, a bottom face 21b, a front end portion 21c, a rear end portion 21d, and two side end portions 21e. The bottom face 21b is positioned at the opposite side of the upper face 21a. The rear end portion 21d is positioned at the opposite side of the front end portion 21c.

The upper face 21a is directed in a positive direction along the Z-axis, that is, the upward direction. The bottom face 21b is directed in a negative direction along the Z-axis, that is, the downward direction. The front end portion 21c is an end portion of the first housing 21 in a positive direction along the Y-axis, that is, the forward direction. The rear end portion 21d is an end portion of the first housing 21 in a negative direction along the Y-axis, that is, the rearward direction. Each of the two side end portions 21e is an end portion of the first housing 21 in a direction along the X-axis, that is, the leftward direction or the rightward direction.

The keyboard 22, the touch pad 23, and the fingerprint detection module 24 are provided on the upper face 21a. The speakers 25 and the card reading device 26 are provided in the front end portion 21c. The connectors 27 is provided in one of the side end portions 21e.

The keyboard 22 is a device configured to input information in the portable computer 10. The keyboard 22 is provided with a pointing stick 22a. The pointing stick 22a is a pointing device.

The touch pad 23 is a pointing device. The touch pad 23 is disposed closer to the front end portion 21c of the first housing 21 than the keyboard 22 is. The touch pad 23 is provided with two buttons 23a for a click operation.

The fingerprint detection module 24 is a device configured to detect a fingerprint of the user of the portable computer 10. The fingerprint detection module 24 is disposed closer to the front end portion 21c of the first housing 21 than the touch pad 23 is. Incidentally, the fingerprint detection module 24 may be disposed at another location such as between the two buttons 23a of the touch pad 23.

Each of the speakers 25 is a device configured to generate a sound. Two speaker openings 31 are provided at the front end portion 21c of the first housing 21. Each of the speakers 25 emits the sound to the outside of the first housing 21 through the corresponding speaker opening 31.

The card reading device 26 is a device configured to perform read and write of data of a memory card M, for example. A first insertion port 32 is provided in the front end portion 21c of the first housing 21. The first insertion port 32 is an example of a second opening. For example, the memory card M is inserted into the card reading device 26 or extracted from the card reading device 26 through the first insertion port 32.

The plurality of connectors 27 include various types of connectors such as USB connectors. A plurality of connector openings 33 are provided on one of the side end portions 21e of the first housing 21. Each of the connectors 27 is inserted into or extracted from a corresponding plug through the corresponding connector opening 33.

The display unit 12 is attached to the rear end portion 21d of the first housing 21 of the base portion 11 by the hinge portion 13. The display unit 12 is rotatable between a closing position at which the display unit 12 covers the upper face 21a of the first housing 21 and an opening position at which the display unit 12 is raised from the rear end portion 21d of the first housing 21.

The display unit 12 includes a second housing 41, a display module 42, and a camera 43. The second housing 41 accommodates the display module 42 and the camera 43. The second housing 41 further accommodates, for example, an antenna.

The second housing 41 is formed substantially in a rectangular box shape. The second housing 41 maybe formed in another shape. The second housing 41 includes a front face 41a, a proximal end portion 41b, and a distal end portion 41c.

The front face 41a faces the upper face 21a of the first housing 21 in a case in which the display unit 12 is at the closing position. The proximal end portion 41b is connected to the base portion 11 through the hinge portion 13 in a rotatable manner. The distal end portion 41c is positioned at the opposite side of the proximal end portion 41b.

A display opening 45 is provided in the front face 41a of the second housing 41. The display module 42 includes a screen 42a to display an image. The screen 42a is exposed to the outside of the second housing 41 through the display opening 45.

The camera 43 is disposed closer to the distal end portion 41c of the second housing 41 than the display module 42 is. The camera 43 captures an image in a direction in which the front face 41a is directed by a lens provided in the front face 41a, for example.

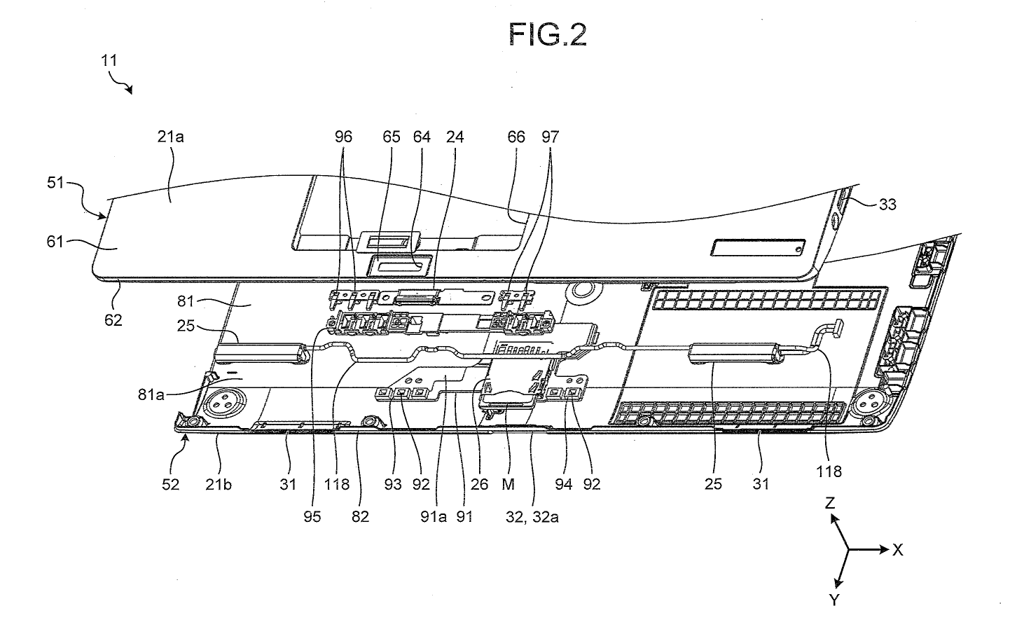

FIG. 2 is an exemplary perspective view illustrating a part of the exploded base portion 11 according to the embodiment. As illustrated in FIG. 2, the first housing 21 includes a top cover 51 and a bottom cover 52. The bottom cover 52 is an example of a second wall. Each of the top cover 51 and the bottom cover 52 can be referred to also as a member, for example.

Each of the top cover 51 and the bottom cover 52 of the first housing 21 is made of a conductor such as a magnesium alloy. The first housing 21 may be made of another material such as synthetic resin. For example, in a case in which the first housing 21 is made of the synthetic resin, an inner surface of the first housing 21 may be covered by a metal film.

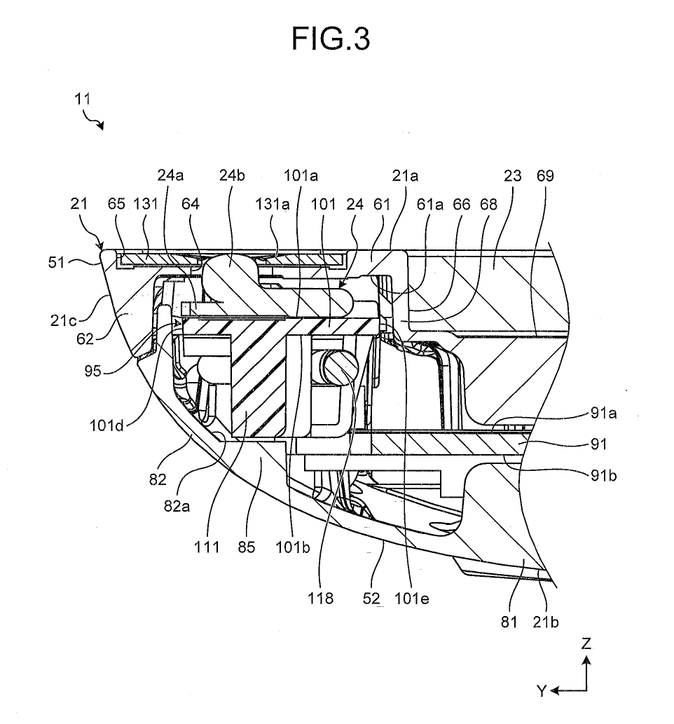

FIG. 3 is an exemplary cross-sectional view illustrating a part of the base portion 11 according to the embodiment. As illustrated in FIG. 3, the top cover 51 includes an upper wall 61 and a first end wall 62. The upper wall 61 is an example of a first wall.

The upper wall 61 forms the upper face 21a of the first housing 21. The upper wall 61 is provided with an exposure port 64, a first concave portion 65, and a second concave portion 66. The exposure port 64 is an example of a first opening.

The exposure port 64 is a substantially rectangular hole which penetrates the upper wall 61 in the direction along the Z-axis, and extends in the direction along the X-axis. The exposure port 64 is opened at the upper face 21a formed by the upper wall 61 and an inner face 61a of the upper wall 61. The inner face 61a is positioned at the opposite side of the upper face 21a, and faces the inside of the first housing 21.

The first concave portion 65 is a recess which is provided in the upper face 21a. A depth of the first concave portion 65 is smaller than a thickness of the upper wall 61. The first concave portion 65 overlaps with the exposure port 64 in a case in which the upper face 21a is seen in a plan view, that is, in a case in which the portable computer 10 is seen from the direction along the Z-axis. That is, the exposure port 64 is provided at a position at which the first concave portion 65 is provided.

The second concave portion 66 is a recess which is provided in the upper face 21a. The second concave portion 66 accommodates the touch pad 23. The exposure port 64 and the first concave portion 65 are disposed between the front end portion 21c of the first housing 21 and the second concave portion 66. The upper wall 61 includes an enclosure wall 68 and a support wall 69 which form the second concave portion 66.

The enclosure wall 68 is formed substantially in a rectangular frame shape. The enclosure wall 68 protrudes from the inner face 61a of the upper wall 61 in the negative direction along the Z-axis. The enclosure wall 68 surrounds the touch pad 23 which is accommodated in the second concave portion 66. The support wall 69 blocks an end portion in the negative direction along the Z-axis of the enclosure wall 68. The support wall 69 supports the touch pad 23 which is accommodated in the second concave portion 66.

The first end wall 62 protrudes approximately in the negative direction along the Z-axis from the upper wall 61 in the front end portion 21c of the first housing 21. The first end wall 62 forms a part of the front end portion 21c. The first end wall 62 may form the entire front end portion 21c.

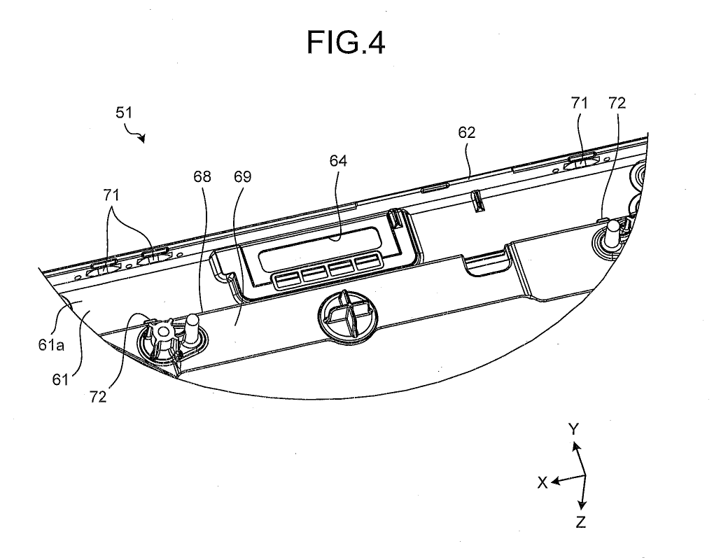

FIG. 4 is an exemplary perspective view illustrating apart of the top cover 51 according to the embodiment. As illustrated in FIG. 4, the top cover 51 includes a plurality of fitting recesses 71 and a plurality of first fitting claws 72. Each of the fitting recess 71 and the first fitting claw 72 is an example of a first holding portion.

Each of the plurality fitting recesses 71 is provided at a position spaced apart from the upper wall 61 in the negative direction along the Z-axis. The plurality fitting recesses 71 are arranged while being spaced apart from each other in the direction along the X-axis.

Each of the plurality of first fitting claws 72 is provided at a position spaced apart from the upper wall 61 in the negative direction along the Z-axis. The plurality of first fitting claws 72 are arranged while being spaced apart from each other in the direction along the X-axis. The first fitting claw 72 protrudes toward the positive direction along the Y-axis from the enclosure wall 68. In other words, the first fitting claw 72 protrudes toward the first end wall 62 from the enclosure wall 68.

The bottom cover 52 illustrated in FIG. 3 is screwed to the top cover 51, for example. The top cover 51 and the bottom cover 52, which are fixed to each other, form the first housing 21. The bottom cover 52 includes a bottom wall 81 and a second end wall 82.

The bottom wall 81 forms the bottom face 21b of the first housing 21. The bottom wall 81 is spaced apart from the upper wall 61 in the negative direction along the Z-axis. An inner face 81a of the bottom wall 81 and the inner face 61a of the upper wall 61 oppose each other. The inner face 81a is positioned at the opposite side of the bottom face 21b, and faces the inside of the first housing 21.

The second end wall 82 protrudes approximately in the positive direction along the Z-axis from the bottom wall 81 in the front end portion 21c of the first housing 21. The second end wall 82 forms a part of the front end portion 21c. The second end wall 82 may form the entire front end portion 21c. The second end wall 82 is spaced apart from the upper wall 61 in the negative direction along the Z-axis. Apart of the second end wall 82 may be in contact with the upper wall 61.

The first and second end walls 62 and 82 extend in a direction obliquely crossing the Z-axis so as to be directed in the positive direction along the Y-axis as approaching the upper wall 61 from the bottom wall 81. In other words, the first and second end walls 62 and 82 extend to approach the upper wall 61 as being directed in the positive direction along the Y-axis.

A receiving portion 85 is provided in an inner face 82a of the second end wall 82. The inner face 82a faces the inside of the first housing 21. The receiving portion 85 protrudes from the inner face 82a, and forms a substantially flat face which opposes the upper wall 61. The receiving portion 85 may be a recess which is provided in the inner face 82a.

As illustrated in FIG. 2, the first insertion port 32 is provided in the second end wall 82. The second end wall 82 includes a first edge 32a to form the first insertion port 32. Incidentally, the first insertion port 32 and the first edge 32a may be provided in the first end wall 62.

Each of the speaker openings 31 is formed by cutouts respectively provided in the top cover 51 and the bottom cover 52. FIG. 2 illustrates the cutout as the speaker opening 31 for understanding.

The base portion 11 further includes a substrate 91, a plurality of LEDs 92, a plurality of first sponges 93, a plurality of second sponges 94, an attachment member 95, a plurality of first lenses 96, and a plurality of second lenses 97. Each of the plurality of LEDs 92 is an example of a fourth component. Each of the plurality of first sponges 93 and the plurality of second sponges 94 is an example of an interposed member. The attachment member 95 is an example of the member. Each of the plurality of first and second lenses 96 and 97 is an example of the lens.

The substrate 91, the plurality of LEDs 92, the plurality of first sponges 93, the plurality of second sponges 94, the attachment member 95, the plurality of first lenses 96, and the plurality of second lenses 97 are accommodated in the first housing 21. The substrate 91, the plurality of LEDs 92, the plurality of first sponges 93, the plurality of second sponges 94, the attachment member 95, the plurality of first lenses 96, and the plurality of second lenses 97 are positioned between the upper wall 61 of the top cover 51 and the bottom cover 52.

The substrate 91 is a printed circuit board (PCB), for example. The substrate 91 may be another substrate. As illustrated in FIG. 3, the substrate 91 includes a first mounting face 91a and a second mounting face 91b.

The first mounting face 91a and the inner face 61a of the upper wall 61 oppose each other. The card reading device 26 and various types of components are mounted to the first mounting face 91a. The substrate 91 to which the card reading device 26 is mounted is an example of a third component.

The second mounting face 91b is positioned at the opposite side of the first mounting face 91a. Various types of components are mounted to the second mounting face 91b. The second mounting face 91b and at least one of the inner face 81a of the bottom wall 81 and the inner face 82a of the second end wall 82 oppose each other.

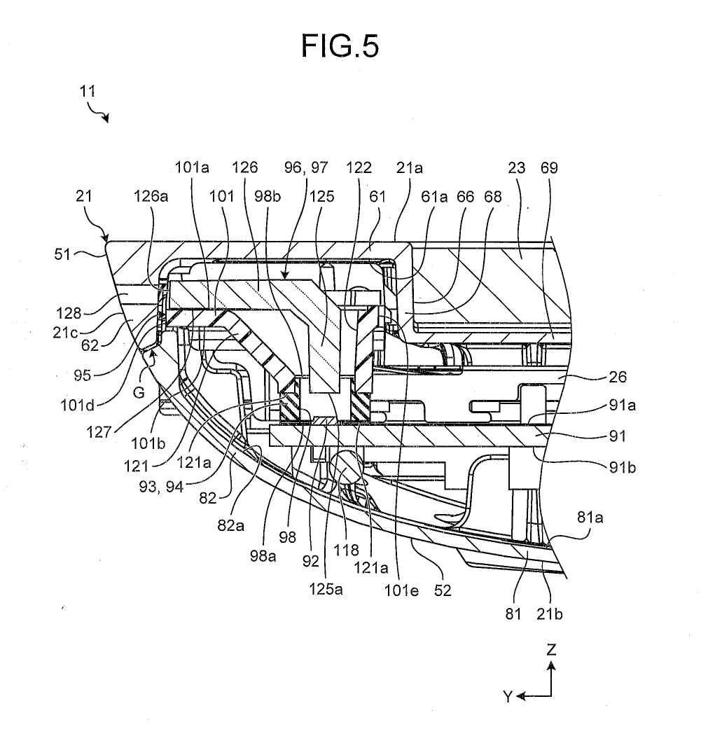

FIG. 5 is an exemplary cross-sectional view illustrating a part of the base portion 11 at a position different from that of FIG. 3 according to the embodiment. As illustrated in FIG. 5, the plurality of LEDs 92 are mounted to the first mounting face 91a of the substrate 91. In other words, the plurality of LEDs 92 are provided on the substrate 91.

Each of the plurality of LEDs 92 emits light. For example, each of the plurality of LEDs 92 emits light at the time of manual operation and data processing of the portable computer 10, and when the portable computer 10 can be communicated and is communicated. The LED 92 may emit light in another case.

Each of the plurality of first sponges 93 and the plurality of second sponges 94 is made of a black synthetic resin, for example. In other words, the first and second sponges 93 and 94 are colored. In the embodiment, the colored first and second sponges 93 and 94 are not transparent and shields or attenuates light incident to the first and second sponges 93 and 94.

Each Young's modulus of the first and second sponges 93 and 94 may be lower than a Young's modulus of the substrate 91. In addition, each Young's modulus of the first and second sponges 93 and 94 is lower than a Young's modulus of the card reading device 26.

Each of the first and second sponges 93 and 94 is formed substantially in a quadrangular tube shape. Each of the first and second sponges 93 and 94 may be formed in another shape. The first and second sponges 93 and 94 are attached to the first mounting face 91a of the substrate 91 by adhesion, for example.

A hole 98 is provided in each of the plurality of first and second sponges 93 and 94. The hole 98 penetrates the corresponding first or second sponge 93 or 94 in the direction along the Z-axis. The hole 98 includes a first opening end 98a and a second opening end 98b.

The first opening end 98a is an end of the hole 98 in the negative direction along the Z-axis, and faces the substrate 91. The LED 92 is inserted to the hole 98 from the first opening end 98a. In other words, each of the first and second sponges 93 and 94 surrounds the corresponding LED 92. The second opening end 98b is an end of the hole 98 in the positive direction along the Z-axis, and is positioned at the opposite side of the first opening end 98a.

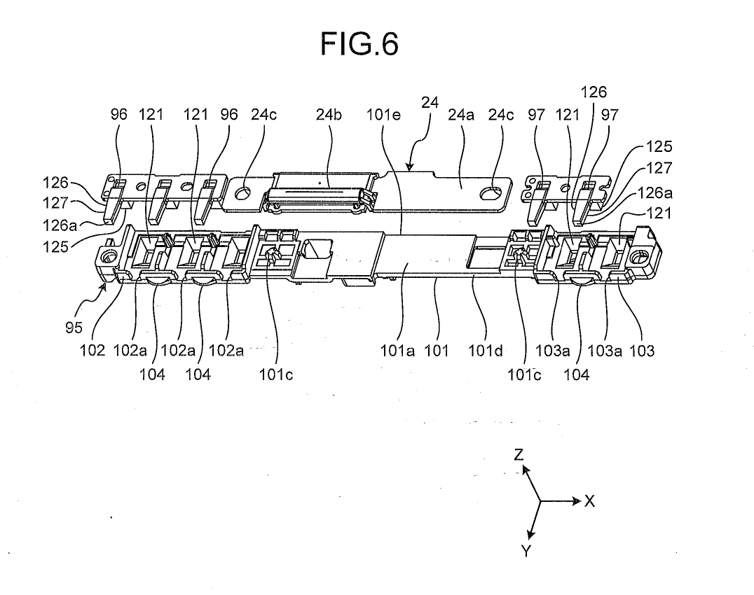

FIG. 6 is an exemplary perspective view illustrating the fingerprint detection module 24, the attachment member 95, the plurality of first lenses 96, and the plurality of second lenses 97 according to the embodiment. The attachment member 95 illustrated in FIG. 6 is made of a colored synthetic resin with an insulating property, for example. In this embodiment, the colored attachment member 95 is not transparent, and shields or attenuates light incident to the attachment member 95. A Young's modulus of the attachment member 95 is lower than a Young's modulus of the first housing 21. The attachment member 95 may be made of another material.

The attachment member 95 includes an attachment portion 101, a first holding rib 102, a second holding rib 103, and a plurality of second fitting claws 104. The attachment portion 101 can be referred to also as a wall, a plate, or a part, for example. Each of the first and second holding ribs 102 and 103 is an example of a second support portion.

The attachment portion 101 is formed substantially in a rectangular plate shape. The attachment portion 101 extends in the direction along the X-axis. The attachment portion 101 may be formed in another shape. As illustrated in FIG. 3, the attachment portion 101 includes a first face 101a and a second face 101b.

The first face 101a and the inner face 61a of the upper wall 61 oppose each other. The second face 101b is positioned at the opposite side of the first face 101a. The second face 101b and at least one of the inner face 81a of the bottom wall 81 and the inner face 82a of the second end wall 82 oppose each other.

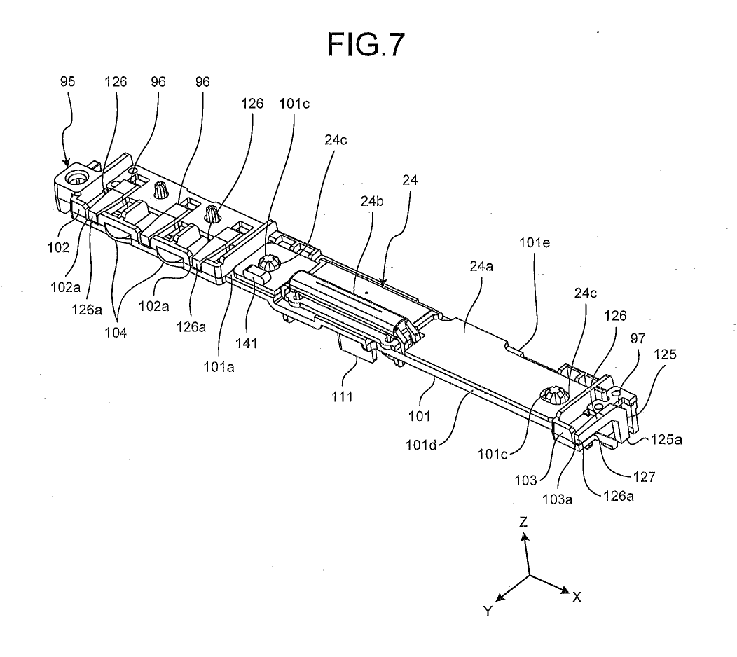

FIG. 7 is an exemplary perspective view illustrating a part of the attachment member 95 to which the fingerprint detection module 24 and the plurality of first and second lenses 96 and 97 are attached, according to the embodiment. As illustrated in FIG. 7, the fingerprint detection module 24 is attached to the first face 101a of the attachment portion 101.

The fingerprint detection module 24 includes a module substrate 24a and a sensor unit 24b. The module substrate 24a is a PCB, for example. The sensor unit 24b is mounted to the module substrate 24a.

The module substrate 24a of the fingerprint detection module 24 is bonded to the first face 101a of the attachment portion 101 by, for example, a double-sided tape. The fingerprint detection module 24 may be bonded to the attachment portion 101 by, for example, an adhesive, or attached to the attachment portion 101 using another means such as screwing, fitting, or claw engaging. When the module substrate 24a is attached to the first face 101a, the sensor unit 24b protrudes from the module substrate 24a in the positive direction along the Z-axis, that is, the direction in which the first face 101a is directed.

The attachment portion 101 further includes a plurality of pins 101c. Each of the pins 101c protrudes from the first face 101a. Each of the pins 101c is inserted into a hole 24c provided in the module substrate 24a of the fingerprint detection module 24. The pin 101c positions the fingerprint detection module 24.

Each of the first holding rib 102 and the second holding rib 103 is positioned at a front end portion 101d of the attachment portion 101. The front end portion 101d is an end portion in the positive direction along the Y-axis of the attachment portion 101.

In other words, the front end portion 101d is a part closer to the front end portion 21c of the first housing 21 than the other parts in the attachment portion 101.

The first and second holding ribs 102 and 103 protrude from the first face 101a in the positive direction along the Z-axis. The fingerprint detection module 24 is disposed between the first holding rib 102 and the second holding rib 103 in the direction along the X-axis. The first and second holding ribs 102 and 103 may be provided at another position.

A plurality of concave portions 102a are provided in the first holding rib 102. A plurality of concave portions 103a are provided in the second holding rib 103. Each of the concave portions 102a and 103a is a cutout opened at the positive direction along the Z-axis.

The plurality of second fitting claws 104 protrude from the front end portion 101d of the attachment portion 101 in the positive direction along the Y-axis. The plurality of second fitting claws 104 are arranged while being spaced apart from each other in the direction along the X-axis. The plurality of second fitting claws 104 are disposed at positions corresponding to the plurality fitting recesses 71.

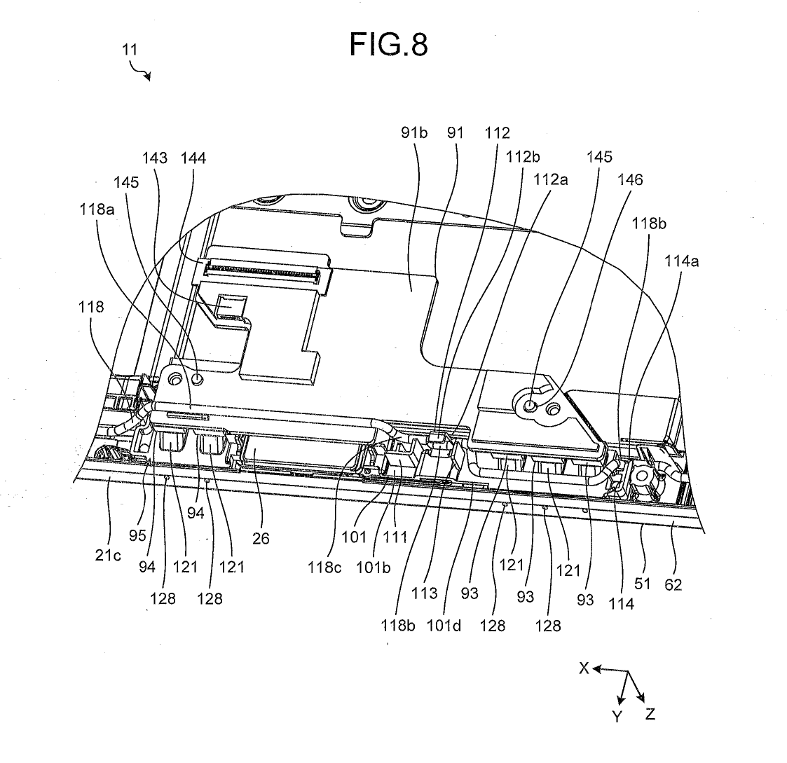

FIG. 8 is an exemplary perspective view illustrating a part of the base portion 11 according to the embodiment by removing the bottom cover 52. As illustrated in FIG. 8, the attachment member 95 further includes a first rib 111, a second rib 112, a third rib 113, and a fourth rib 114. Each of the first to fourth ribs 111 to 114 is an example of a first support portion. The first rib 111 and the third rib 113 are examples of fourth holding portions.

The first to fourth ribs 111 to 114 protrude from the second face 101b of the attachment portion 101 in the negative direction along the Z-axis. As illustrated in FIG. 3 regarding the first rib 111, each of the first to fourth ribs 111 to 114 protrudes toward the corresponding receiving portion 85 of the bottom cover 52. Each of the first to fourth ribs 111 to 114 may protrude toward another part of the bottom cover 52.

The first rib 111 overlaps with the sensor unit 24b of the fingerprint detection module 24 in the direction along the Z-axis. Each of the second to fourth ribs 112 to 114 may overlap with the fingerprint detection module 24 in the direction along the Z-axis.

As illustrated in FIG. 8, the second rib 112 includes a protruding portion 112a and a claw 112b. The protruding portion 112a is an example of a third holding portion. The claw 112b is an example of a second holding portion.

The protruding portion 112a protrudes from the second face 101b of the attachment portion 101 in the negative direction along the Z-axis. The claw 112b extends in the positive direction along the Y-axis from an end portion of the protruding portion 112a in the negative direction along the Z-axis. The protruding portion 112a is interposed between the attachment portion 101 and the claw 112b. The claw 112b is spaced apart from the attachment portion 101 in the negative direction along the Z-axis, and is positioned between the attachment portion 101 and the bottom cover 52.

The protruding portion 112a of the second rib 112 is positioned between the first rib 111 and the third rib 113 in the direction along the X-axis. The protruding portion 112a of the second rib 112 is spaced apart from the first and third ribs 111 and 113, respectively, in the direction along the Y-axis. The third rib 113 is positioned between the second rib 112 and the fourth rib 114 in the direction along the X-axis.

The fourth rib 114 includes a claw 114a. The claw 114a is spaced apart from the attachment portion 101 in the negative direction along the Z-axis, and is positioned between the attachment portion 101 and the bottom cover 52.

As illustrated in FIG. 5, the substrate 91 overlaps with the attachment member 95 in the direction along the Z-axis. A part of the substrate 91 is positioned between the attachment member 95 and the bottom cover 52 in the direction along the Z-axis.

The card reading device 26 mounted on the substrate 91 is positioned between the attachment member 95 and the substrate 91 in the direction along the Z-axis. Each of the plurality of first and second sponges 93 and 94 attached to the substrate 91 is positioned between the attachment member 95 and the substrate 91 in the direction along the Z-axis.

As illustrated in FIG. 8, the first to third ribs 111 to 113 are disposed between the card reading device 26 and the plurality of first sponges 93 in the direction along the X-axis. The plurality of first sponges 93 are disposed between the third rib 113 and the fourth rib 114 in the direction along the X-axis. The card reading device 26 is disposed between the plurality of first sponges 93 and the plurality of second sponges 94 in the direction along the X-axis.

As illustrated in FIG. 2, each of a plurality of harnesses 118 are extended from the two speakers 25. The harness 118 is an example of a wiring. The harnesses 118 connect the two speakers 25, and connect the speaker 25 with the motherboard, for example. The harness 118 may connect the speaker 25 with another component.

As illustrated in FIG. 8, the harness 118 includes a detour portion 118a, a plurality of vertical hold portions 118b, and a horizontal hold portion 118c. The detour portion 118a is an example of a second part. Each of the plurality of vertical hold portions 118b is an example of a first part. The horizontal hold portion 118c is an example of a third part.

The detour portion 118a, the vertical hold portion 118b, and the horizontal hold portion 118c are parts of the harness 118. In the embodiment, the detour portion 118a, the vertical hold portion 118b, and the horizontal hold portion 118c extend in the direction along the X-axis. The harness 118 includes apart extended in another direction.

The detour portion 118a is disposed between the substrate 91 and the bottom cover 52. For example, the detour portion 118a is extended along the second mounting face 91b of the substrate 91. The detour portion 118a may be held to the substrate 91 by, for example, a tape.

One of the vertical hold portions 118b is disposed between the claw 112b of the second rib 112 and the attachment portion 101. The vertical hold portion 118b is held between the claw 112b and the attachment portion 101 by the claw 112b. The claw 112b and the attachment portion 101 prevent movement of the vertical hold portion 118b in the direction along the Z-axis.

The other one of the vertical hold portions 118b is disposed between the claw 114a of the fourth rib 114 and the attachment portion 101. The vertical hold portion 118b is held between the claw 114a and the attachment portion 101 by the claw 114a. The claw 114a and the attachment portion 101 prevent movement of the vertical hold portion 118b in the direction along the Z-axis.

The horizontal hold portion 118c is positioned between the first and third ribs 111 and 113 and the protruding portion 112a of the second rib 112 in the direction along the Y-axis. The direction along the Y-axis is an example of a direction which is orthogonal to a direction in which the third part extends, and further, is orthogonal to a direction which is directed from the first wall to the second wall. The horizontal hold portion 118c includes the vertical hold portion 118b between the claw 112b and the attachment portion 101.

The horizontal hold portion 118c is held by the first and third ribs 111 and 113 and the protruding portion 112a of the second rib 112. The first and third ribs 111 and 113 and the protruding portion 112a of the second rib 112 prevent movement of the horizontal hold portion 118c in the direction along the Y-axis.

As described above, the first to fourth ribs 111 to 114 support the harness 118. The first to fourth ribs 111 to 114 prevent movement of the harness 118 in the direction along the Y-axis and the direction along the Z-axis. The direction along the Y-axis and the direction along the Z-axis are orthogonal to direction in which the detour portion 118a, the vertical hold portion 118b, and the horizontal hold portion 118c of the harness 118 extend.

As illustrated in FIG. 5, the attachment member 95 further includes a plurality of tubular portions 121. Each of the plurality of tubular portions 121 is formed substantially in a quadrangular frustum tube shape. Each of the tubular portions 121 protrudes from the second face 101b of the attachment portion 101 in the negative direction along the Z-axis.

A through hole 122 is provided in the tubular portion 121. The through hole 122 penetrates the attachment portion 101 and the tubular portion 121 in the direction along the Z-axis. One end of the through hole 122 is opened at the first face 101a of the attachment portion 101. The other end of the through hole 122 is opened at an end portion 121a of the tubular portion 121. The end portion 121a is an end of the tubular portion 121 which is positioned at the opposite side of a part which is connected to the attachment portion 101.

The end portion 121a of the tubular portion 121 faces the corresponding LED 92. The end portion 121a is spaced apart from the corresponding LED 92 in the positive direction along the Z-axis. The end portion 121a is in contact with the first or second sponge 93 or 94 that surrounds the corresponding LED 92. In other words, each of the first and second sponges 93 and 94 is positioned between the substrate 91 and the tubular portion 121 of the attachment member 95. A hole 98 of the first and second sponges 93 and 94 is connected to the through hole 122 of the attachment member 95.

Each of the plurality of first and second lenses 96 and 97 is made of a transparent synthetic resin. Each of the plurality of first and second lenses 96 and 97 may be made of another material.

As illustrated in FIG. 6, the plurality of first lenses 96 are connected to each other, and are formed in an integrated manner. The plurality of first lenses 96 may be separated from each other. The plurality of second lenses 97 are connected to each other, and are formed in an integrated manner. The plurality of second lenses 97 may be separated from each other.

Each of the first and second lenses 96 and 97 is attached to the first face 101a of the attachment portion 101. In this embodiment, each of the first and second lenses 96 and 97 is welded to the attachment portion 101. Each of the first and second lenses 96 and 97 may be attached to the attachment portion 101 by another means, for example, an adhesive.

As illustrated in FIG. 5, each of the first and second lenses 96 and 97 is formed substantially in an L shape. Each of the first and second lenses 96 and 97 may be formed in another shape. Each of the first and second lenses 96 and 97 includes a first extension portion 125 and a second extension portion 126.

The first extension portion 125 extends in the direction along the Z-axis. The first extension portion 125 includes a first end face 125a. The first end face 125a is one end face of the first or second lenses 96 or 97. The first end face 125a is directed in the negative direction along the Z-axis.

The second extension portion 126 extends in the direction along the Y-axis from the first extension portion 125. The second extension portion 126 includes a second end face 126a. The second end face 126a is the other end face of the first or second lenses 96 or 97. The second end face 126a is directed in the positive direction along the Y-axis. That is, the direction in which the second end face 126a is directed crosses the direction in which the first end face 125a is directed.

The first extension portion 125 of the first and second lenses 96 and 97 is inserted into the corresponding through hole 122. The first extension portion 125 is surrounded by the tubular portion 121. Thus, the tubular portion 121 of the attachment member 95 is positioned between the first extension portion 125 of the corresponding first or second lens 96 or 97 and the first housing 21.

The first end face 125a of the first lens 96 opposes the hole 98 of the first sponge 93. The first end face 125a of the second lens 97 opposes the hole 98 of the second sponge 94. The first end face 125a may be disposed inside the hole 98. The first end face 125a faces the corresponding LED 92 through the hole 98.

Apart of the second extension portion 126 of the first lens 96 is fitted in the concave portion 102a of the corresponding first holding rib 102. A part of the second extension portion 126 of the second lens 97 is fitted in the concave portion 103a of the corresponding second holding rib 103.

The second extension portion 126 includes a circumferential face 127 extended from the second end face 126a. The circumferential face 127 in the embodiment is a face having substantially a quadrangular tubular shape, for example. The circumferential face 127 may be also formed in another shape such as a cylindrical shape.

Each of the first and second holding ribs 102 and 103 supports the circumferential face 127 of the corresponding first or second lens 96 or 97, which is fitted in each of the concave portions 102a and 103a in a plurality of directions.

In this embodiment, the first holding rib 102 supports the circumferential face 127 of the first lens 96 fitted in the concave portion 102a from the downward direction which is the negative direction along the Z-axis, and from the rightward direction and the leftward direction which are the directions along the X-axis. The downward direction is an example of a first direction. Each of the rightward direction and the leftward direction is an example of a second direction. The first holding rib 102 prevents movement of the first lens 96 in the negative direction along the Z-axis and in the direction along the X-axis.

Similarly, the second holding rib 103 supports the circumferential face 127 of the second lens 97 fitted in the concave portion 103a from the downward direction which is the negative direction along the Z-axis, and from the rightward direction and the leftward direction which are the directions along the X-axis. The second holding rib 103 prevents movement of the second lens 97 in the negative direction along the Z-axis and in the direction along the X-axis.

The respective second extension portions 126 of the first and second lenses 96 and 97 are covered by the attachment member 95, respectively, from the downward direction which is the negative direction along the Z-axis, and from the leftward direction and the rightward direction which are the directions along the X-axis. The attachment portion 101 of the attachment member 95 is positioned between the second extension portion 126 of the corresponding first or second lens 96 or 97 and the first housing 21. The respective second extension portions 126 of the first and second lenses 96 and 97 are covered by the top cover 51 of the first housing 21 from the upward direction which is the positive direction along the Z-axis.

A plurality of lens openings 128 are provided in the front end portion 21c of the first housing 21. Each of the plurality of lens openings 128 is an example of a fourth opening. Each of the lens openings 128 is provided in the first end wall 62 of the top cover 51, and penetrates the first end wall 62 in the direction along the Y-axis. The lens opening 128 may be provided in the second end wall 82 of the bottom cover 52, for example.

The respective second end faces 126a of the first and second lenses 96 and 97 face the corresponding lens openings 128. The plurality of lens openings 128 exposes the second end faces 126a of the first and second lenses 96 and 97 to the outside of the portable computer 10.

The LED 92 emits light toward the first end face 125a of the corresponding first or second lens 96 or 97 through the hole 98 of the corresponding first or second sponge 93 or 94. The first or second lens 96 or 97 reflects the light incident to the first end face 125a from the LED 92 inside the corresponding first or second lens 96 or 97, and emits the reflected light from the second end face 126a. The light emitted from the second end face 126a is emitted to the outside of the first housing 21 through the lens opening 128.

The light emitted from the LED 92 is shielded by the first or second sponge 93 or 94 that surrounds the corresponding LED 92. The light incident to the first and second lenses 96 and 97 may be leaked from a part other than the first and second end faces 125a and 126a of the first and second lenses 96 and 97. The light leaked from the first or second lens 96 or 97 is shielded by the attachment portion 101 and the tubular portion 121 that cover the corresponding first or second lens 96 or 97.

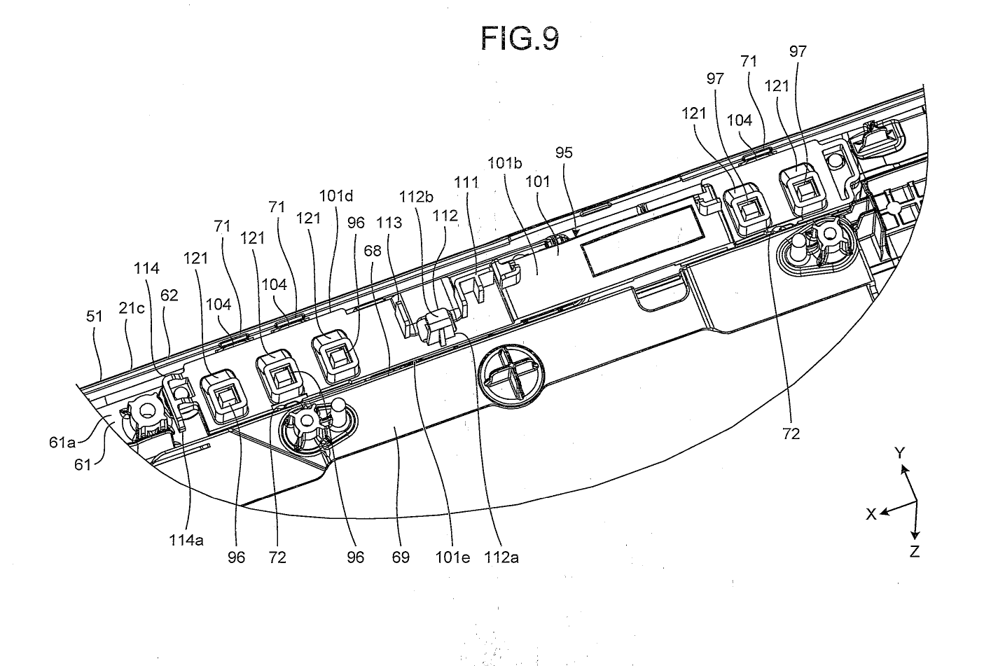

FIG. 9 is an exemplary perspective view illustrating the top cover 51 and the attachment member 95 according to the embodiment. As illustrated in FIG. 9, the above-described attachment member 95 to which the fingerprint detection module 24 and the plurality of first and second lenses 96 and 97 are attached is attached to the first housing 21.

The attachment portion 101 of the attachment member 95 is disposed between the first end wall 62 and the enclosure wall 68 of the top cover 51. A distance between the first end wall 62 and the enclosure wall 68 in the direction along the Y-axis is slightly greater than a width (length in the direction along the Y-axis) of the attachment portion 101.

The plurality of second fitting claws 104 of the attachment member 95 are fitted in the plurality fitting recesses 71 provided in the first end wall 62. The fitting recess 71 of the first end wall 62 supports the second fitting claw 104 of the attachment member 95, thereby attaching the attachment member 95 to the first housing 21.

The first fitting claw 72 of the enclosure wall 68 supports an end portion 101e of the attachment portion 101, thereby holding the attachment portion 101 between the upper wall 61 of the top cover 51 and the first fitting claw 72. The rear end portion 101e is positioned at the opposite side of the front end portion 101d of the attachment portion 101. In other words, the first fitting claw 72 supports the rear end portion 101e of the attachment portion 101, thereby attaching the attachment member 95 to the first housing 21.

The attachment member 95 made of the synthetic resin is elastically deformed when being attached to the first housing 21. In other words, the attachment member 95 is attached to the first housing 21 by being elastically deformed.

As described above, the fitting recess 71 and the first fitting claw 72 as the examples of the first holding portion attaches the attachment member 95 to the first housing 21. The example of the first holding portion may be a groove in which the front end portion 101d of the attachment portion 101 is fitted, a claw allowing the attachment portion 101 to be held against the upper wall 61, or another means that can be attached by the attachment member 95 being elastically deformed, for example.

When the attachment member 95 is attached to the first housing 21 by the fitting recess 71 and the first fitting claw 72 as illustrated in FIG. 3, the module substrate 24a of the fingerprint detection module 24 is positioned between the attachment member 95 and the upper wall 61. In addition, the sensor unit 24b of the fingerprint detection module 24 is inserted into the exposure port 64 of the upper wall 61. The sensor unit 24b is exposed to the outside of the first housing 21 through the exposure port 64.

A frame member 131 is fitted in the first concave portion 65 of the upper wall 61. The frame member 131 is formed substantially in a rectangular frame shape. The frame member 131 surrounds the sensor unit 24b to be exposed from the exposure port 64.

A guide face 131a is provided in the frame member 131. The guide face 131a is a surface of the frame member 131 provided around the sensor unit 24b. The guide face 131a is inclined toward the negative direction along the Z-axis as being directed to the sensor unit 24b.

When a user's finger moves along the surface of the sensor unit 24b, the fingerprint detection module 24 detects a fingerprint of the user. The guide face 131a is provided so as to guide the user's finger to the sensor unit 24b.

The first to fourth ribs 111 to 114 of the attachment member 95 are supported by the corresponding receiving portion 85 of the bottom cover 52. The first to fourth ribs 111 to 114 may be slightly spaced apart from the receiving portion 85.

When the user's finger presses the sensor unit 24b, the fingerprint detection module 24 and the attachment member 95 are pressed in the negative direction along the Z-axis. In a case in which the first to fourth ribs 111 to 114 are slightly spaced apart from the receiving portion 85, the first to fourth ribs 111 to 114 are in contact with the corresponding receiving portion 85 of the bottom cover 52 when the attachment member 95 is pressed. The receiving portion 85 prevents movement and deformation of the fingerprint detection module 24 and the attachment member 95 by supporting the first to fourth ribs 111 to 114.

The first rib 111 overlaps with the exposure port 64 of the top cover 51 in the direction along the Z-axis. The direction along the Z-axis is an example of the direction directed from the first wall to the second wall. When the sensor unit 24b exposed from the exposure port 64 is pressed, the first rib 111 overlapping with the exposure port 64 is supported by the receiving portion 85.

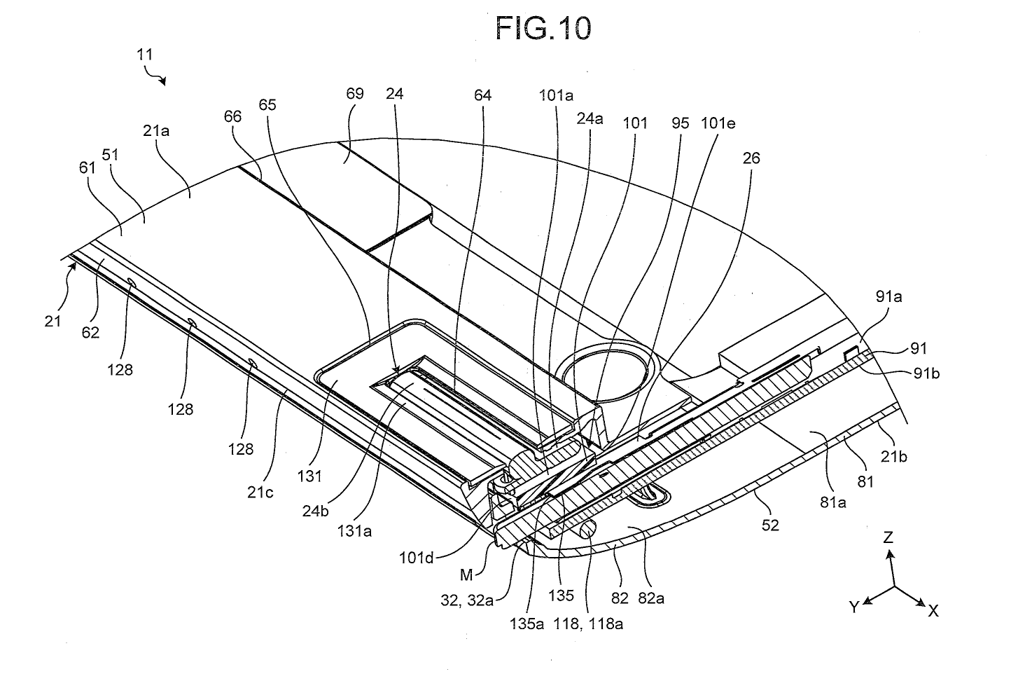

FIG. 10 is an exemplary perspective view illustrating a partially cut-out part of the base portion 11 according to the embodiment. As illustrated in FIG. 10, a second insertion port 135 is provided in the card reading device 26. The second insertion port 135 is an example of a third opening.

The second insertion port 135 is opened toward the first insertion port 32 of the first housing 21. For example, the memory card M is inserted into the second insertion port 135 of the card reading device 26 or is extracted from the second insertion port 135 through the first insertion port 32. The first insertion port 32 of the first housing 21 exposes the second insertion port 135 of the card reading device 26 to the outside of the first housing 21 in a state in which the memory card M is extracted from the second insertion port 135.

The card reading device 26 includes a second edge 135a to form the second insertion port 135. The second edge 135a is spaced apart from the first edge 32a of the second end wall 82 in the negative direction along the Y-axis. In other words, a gap is formed between the first edge 32a and the second edge 135a.

The attachment portion 101 of the attachment member 95 covers the gap between the first edge 32a and the second edge 135a. The attachment portion 101 guides the memory card M to be inserted from the first insertion port 32, and prevents the memory card M from entering the gap between the first edge 32a and the second edge 135a.

As illustrated in FIG. 7, a conductive gasket 141 is attached to the module substrate 24a of the fingerprint detection module 24. The gasket 141 is an example of a connection member. The gasket 141 is attached to the module substrate 24a by a conductive double-sided tape, for example. The gasket 141 may be attached to the module substrate 24a by another means.

The gasket 141 is inserted between the module substrate 24a and the upper wall 61 of the top cover 51. The gasket 141 electrically connects the module substrate 24a and the first housing 21. The module substrate 24a is grounded to the first housing 21 via the gasket 141.

As illustrated in FIG. 8, a first cable connector 143 and a second cable connector 144 are mounted to the second mounting face 91b of the substrate 91. A cable such as a flexible printed circuit board (FPC), which is extended from the fingerprint detection module 24, is connected to the first cable connector 143. The second cable connector 144 is connected to, for example, the motherboard by the cable such as the FPC. The substrate 91 relays between the fingerprint detection module 24 and the motherboard.

The attachment member 95 further includes a plurality of protrusions 145. Each of the protrusions 145 protrudes from the second face 101b of the attachment portion 101. The protrusion 145 is inserted into a hole 146, which is provided in the substrate 91, and positions the substrate 91. The substrate 91 is positioned by the protrusion 145, and is fixed to the top cover 51 of the first housing 21 by a screw, for example.

In general, there is a case in which a relatively small component is directly attached to the housing by a screw, for example. In this case, a small screw is sometimes used, but the small screw has a possibility that causes damage in the screw or a screw hole.

However, the fingerprint detection module 24 is attached to the first housing 21 via the attachment member 95 made of the synthetic resin, in the portable computer 10 according to the embodiment. Accordingly, limitation on a type and a size of a part to be attached by a size of the fingerprint detection module 24 is prevented, the fingerprint detection module 24 is more reliably attached to the first housing 21, and the damage on the portable computer 10 is prevented.

At least a part of the fingerprint detection module 24 is positioned between the attachment member 95 and the upper wall 61 of the first housing 21. Accordingly, the fingerprint detection module 24 is prevented from being detached from the attachment member 95, and the fingerprint detection module 24 is prevented from being in contact with another component inside the first housing 21.

The first housing 21 includes the fitting recess 71 and the first fitting claw 72 that attach the attachment member 95 to the first housing 21 by supporting the second fitting claw 104 of the attachment member 95 and the rear end portion 101e of the attachment portion 101. Accordingly, for example, the attachment member 95 is attached to the first housing 21 without being screwed to the first housing 21, and the number of components is prevented from increasing.

The fingerprint detection module 24 is exposed from the exposure port 64 provided in the upper wall 61. The fingerprint detection module 24 as above is positioned between the attachment member 95 and the upper wall 61. Thus, in a case in which the fingerprint detection module 24 is pressed from the outside, the attachment member 95 supports the fingerprint detection module 24, and the fingerprint detection module 24 is prevented from being detached from the attachment member 95.

The attachment member 95 is positioned between the upper wall 61 and the bottom cover 52. The first to fourth ribs 111 to 114 of the attachment member 95 are supported by the bottom cover 52. Accordingly, since the first to fourth ribs 111 to 114 are supported by the bottom cover 52 in a case in which the fingerprint detection module 24 is pressed from the outside, the fingerprint detection module 24 and the attachment member 95 are prevented from bending. In addition, the increase of a component such as a screw to fix the attachment member 95, and a cushion to support the attachment member 95 is prevented.

The first rib 111 overlaps with the exposure port 64. Accordingly, the first rib 111 directly receives a force to press the fingerprint detection module 24 applied from the outside, and the fingerprint detection module 24 and the attachment member 95 are prevented from bending.

The first to fourth ribs 111 to 114 protrude from the attachment portion 101 to which the fingerprint detection module 24 is attached, and support the harness 118. Accordingly, the harness 118 is prevented from undesirably moving, or being sandwiched between other components. In addition, the increase of the number of components in order to fix the harness 118 is prevented.

The card reading device 26 mounted on the substrate 91 is positioned between the attachment member 95 and the bottom cover 52. In other words, the attachment member 95 is interposed between the fingerprint detection module 24 and the card reading device 26 mounted on the substrate 91. Accordingly, the fingerprint detection module 24 is prevented from being in contact with the card reading device 26 mounted on the substrate 91.

The harness 118 includes the vertical hold portion 118b which is held between the claw 112b of the second rib 112 and the attachment portion 101 by the claw 112b. The claw 112b prevents the vertical hold portion 118b from being lifted toward the bottom cover 52 from the attachment portion 101. Accordingly, the harness 118 is prevented from undesirably moving, or being sandwiched between other components.

The harness 118 includes the detour portion 118a which is positioned between the bottom cover 52 and the card reading device 26 mounted on the substrate 91. The harness 118 can be disposed so as to avoid the card reading device 26 mounted on the substrate 91 by providing the detour portion 118a. The detour portion 118a is spaced apart from the attachment portion 101 by which the vertical hold portion 118b is held. The claw 112b of the second rib 112 restricts the vertical hold portion 118b from being lifted from the attachment portion 101 by the detour portion 118a. Accordingly, the harness 118 is prevented from undesirably moving, or being sandwiched between other components.

The horizontal hold portion 118c of the harness 118 is positioned between the first and third ribs 111 and 113 and the protruding portion 112a of the second rib 112 in a direction (the direction along the Y-axis) which is orthogonal to the direction in which the horizontal hold portion 118c is extended, and is directed from the upper wall 61 to the bottom cover 52, and is held by these first to third ribs 111 to 113. The first to third ribs 111 to 113 prevent the movement of the horizontal hold portion 118c in the direction along the Y-axis. Accordingly, the harness 118 is prevented from undesirably moving, or being sandwiched between other components.

At least a part of the attachment member 95 covers the gap between the first edge 32a and the second edge 135a. Accordingly, for example, the memory card M to be inserted into the first insertion port 32 is prevented from entering space between the first edge 32a and the second edge 135a.

The first and second lenses 96 and 97 emit the light, which has been emitted from the LED 92, through the lens opening 128 provided in the first housing 21. The first and second lenses 96 and 97 as above are attached to the attachment member 95. Since it is possible to handle the attachment member 95 to which the first and second lenses 96 and 97 are attached as a single component at the time of manufacturing the portable computer 10, it becomes easier to manufacture the portable computer 10.

At least a part of the colored attachment member 95 is positioned between the first and second lenses 96 and 97 and the first housing 21. In other words, the attachment member 95 covers the first and second lenses 96 and 97. Accordingly, the light, which has been emitted from the LED 92 and reflected inside the first and second lenses 96 and 97, is prevented from being leaked to the outside from the gap between the top cover 51 and the bottom cover 52. In addition, an increase of a component such as an insulator, which shields the light leaked from the first and second lenses 96 and 97, is prevented.

According to more detailed description, there is a case in which a gap G is present between the first end wall 62 of the top cover 51 and the second end wall 82 of the bottom cover 52 as illustrated in FIG. 5. The attachment portion 101 and the tubular portion 121 of the attachment member 95 are positioned between the gap G and the first and second lenses 96 and 97. Thus, the light, which has been emitted from the LED 92 and is reflected inside the first and second lenses 96 and 97, is prevented from being leaked to the outside of the first housing 21 from the gap G.

The first and second sponges 93 and 94 are positioned between the attachment member 95 and the substrate 91. Accordingly, the attachment member 95 is prevented from damaging the substrate 91. In addition, the LED 92 emits light toward the first end face 125a of the first or second lenses 96 or 97 through the hole of the colored first or second sponges 93 or 94. Accordingly, the leakage of the light emitted from the LED 92 to the outside is prevented without hindering the incidence thereof to the first end face 125a.

The first and second holding ribs 102 and 103 support the circumferential face 127 of the first and second lenses 96 and 97 from the negative direction along the Z-axis and the direction along the X-axis which are orthogonal to each other. Accordingly, the inclination of the first and second lenses 96 and 97 and the change of the positions of the first and second lenses 96 and 97 are prevented.

The first and second lenses 96 and 97 are welded to the attachment member 95. Accordingly, it is possible to handle the attachment member 95 to which the first and second lenses 96 and 97 are welded as a single component at the time of manufacturing the portable computer 10, and thus, it becomes easier to manufacture the portable computer 10. In addition, the increase of a component such as a screw or a double-sided tape to attach the first and second lenses 96 and 97 to the attachment member 95 is prevented.

The fingerprint detection module 24 detects a fingerprint. The fingerprint detection module 24 may pressed by the user at the time of detecting the fingerprint. Thus, the first to fourth ribs 111 to 114 are supported by the bottom cover 52 in a case in which the fingerprint detection module 24 is pressed from the outside, and the fingerprint detection module 24 and the attachment member 95 are prevented from bending.

The fingerprint detection module 24 is bonded to the attachment member 95. Thus, even in a case in which the fingerprint detection module 24 is small, the fingerprint detection module 24 is attached to the attachment member 95 without employing the small screw which is likely to damage the screw hole.

The gasket 141 electrically connects the fingerprint detection module 24 and the first housing 21. Accordingly, it is possible to cause the fingerprint detection module 24, which is attached to the attachment member 95 made of the synthetic resin, to be grounded to the first housing 21.

In the embodiment, the fingerprint detection module 24 is the example of the first component. However, another component such as a switch is an example of the first component in a modified example of the embodiment. For example, in a case in which the switch is pressed from the outside of the first housing 21, the switch is supported by the attachment member 95. In addition, the first to fourth ribs 111 to 114 of the attachment member 95 are supported by the receiving portion 85 of the bottom cover 52. Accordingly, the switch and the attachment member 95 are prevented from bending. The first component is not limited to the component to be operated from the outside such as the fingerprint detection module 24 and the switch.

In addition, the attachment member 95 is attached to the first housing 21 by being supported by the fitting recess 71 and the first fitting claw 72 in the embodiment. However, the attachment member 95 is bonded to the first housing 21 in another modified example of the embodiment. For example, the first face 101a of the attachment portion 101 is bonded to the inner face 61a of the upper wall 61 by a double-sided tape or an adhesive. Accordingly, for example, the attachment member 95 is attached to the first housing 21 without being screwed to the first housing 21, and the number of components is prevented from increasing.

According to at least one of the embodiments described above, the member to which the first component is attached is attached to the housing. Accordingly, the first component is more reliably attached to the housing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing;
a first component in the housing; and
a member to which the first component is attached and which is made of synthetic resin and is attached to the housing.

2. The electronic device according to claim 1, wherein
the housing comprises a first wall, and
at least a part of the first component is between the member and the first wall.

3. The electronic device according to claim 2, wherein
the housing comprises a first holding portion which is configured to support the member and attach the member to the housing.

4. The electronic device according to claim 3, wherein
the first wall is provided with a first opening, and
the first component is configured to be exposed externally through the first opening.

5. The electronic device according to claim 4, wherein
the housing comprises a second wall of which at least a part is spaced apart from the first wall, and
the member comprises a first support portion which is configured to be positioned between the first wall and the second wall and supported by the second wall.

6. The electronic device according to claim 5, wherein
the first support portion overlaps with the first opening in a direction which is directed from the first wall to the second wall.

7. The electronic device according to claim 5, further comprising:
a second component in the housing; and
a wiring which is extended from the second component,
wherein the member comprises an attachment portion to which the first component is attached, and
the first support portion protrudes toward the second wall from the attachment portion, and supports the wiring.

8. The electronic device according to claim 7, further comprising
a third component between the member and the second wall.

9. The electronic device according to claim 8, wherein
the first support portion comprises a second holding portion which is spaced apart from the attachment portion and is between the attachment portion and the second wall, and
the wiring comprises a first part which is held between the second holding portion and the attachment portion by the second holding portion.

10. The electronic device according to claim 9, wherein
the wiring comprises a second part between the second wall and the third component.

11. The electronic device according to claim 8, wherein
the first support portion comprises a third holding portion which protrudes from the attachment portion and a fourth holding portion which is spaced apart from the third holding portion and protrudes from the attachment portion,
the wiring comprises a third part, and
the third part is between the third holding portion and the fourth holding portion in a direction which is orthogonal to a direction in which the third part is extended and orthogonal to a direction which is directed from the first wall to the second wall and is held by the third holding portion and the fourth holding portion.

12. The electronic device according to claim 8, wherein
the housing comprises a first edge which forms a second opening configured to expose the third component externally,
the third component comprises a second edge which forms a third opening which is opened toward the second opening and of which at least a part is spaced apart from the first edge, and
at least a part of the member covers a gap between the first edge and the second edge.

13. The electronic device according to claim 8, further comprising:
a fourth component in the third component and configured to emit light; and
a lens which is attached to the member,
wherein the housing comprises a fourth opening, and
the lens comprises a first end face which faces the fourth component, and a second end face which faces the fourth opening, and is configured to emit light, incident to the first end face from the fourth component, from the second end face.

14. The electronic device according to claim 13, wherein
the member is colored, and
at least a part of the member is between the lens and the housing.

15. The electronic device according to claim 14, further comprising
a colored interposed member which is between the member and the third component, provided with a hole, and has a Young's modulus lower than a Young's modulus of the third component,
wherein the first end face of the lens is directed toward the hole, and
the fourth component is configured to emit light toward the first end face of the lens through the hole.

16. The electronic device according to claim 13, wherein
the lens comprises a circumferential face which is extended from the second end face, and
the member comprises a second support portion which supports the circumferential face from a first direction orthogonal to a direction in which the second end face is directed, and a second direction orthogonal to direction in which the second end face is directed and orthogonal to the first direction.

17. The electronic device according to claim 13, wherein
the lens is made of synthetic resin and is welded to the member.

18. The electronic device according to claim 5, wherein
the first component is exposed from the first opening and is configured to detect a fingerprint.

19. The electronic device according to claim 1, wherein
the first component is bonded to the member.

20. The electronic device according to claim 1, further comprising
a conductive connection member which is attached to the first component,
wherein the housing is made using a conductor, and
the connection member electrically connects the first component and the housing.
